(19) United States
(12) Patent Application Publication
(10) Pub. No.: US 2026/0051093 A1
(43) Pub. Date: Feb. 19, 2026

(54) METHODS, APPARATUS AND SYSTEMS FOR CONFIGURING A VIRTUAL TRY ON APPLICATION USING PRE-CONFIGURED RENDERING PARAMETERS

(71) Applicant: L'Oreal, Paris (FR)

(72) Inventors: KyungMoon LEE, Woodbridge (CA); Michael LY, Toronto (CA); Ying Jhu WANG, Toronto (CA); Yun-Yi LIU, Toronto (CA)

(73) Assignee: L'Oreal, Paris (FR)

(21) Appl. No.: 18/808,805

(22) Filed: Aug. 19, 2024

(51) Int. Cl. G06T 11/60; G06Q 30/0601; G06T 11/00

(52) U.S. Cl. CPC G06T 11/60; G06Q 30/0643; G06T 11/001; G06T 2200/24

(57) ABSTRACT

There is provided methods, apparatus, and systems for configuring a rendering engine of a virtual try on (VTO) system. The method comprises providing, for display by a display device, a graphical user interface (GUI) that configures a profile of a product to try on through operating of the rendering engine of the VTO system, the profile comprising effects data. The method comprises receiving, via a preset control, a first user input selecting a preset of values. The method comprises providing for display in the VTO display region the image with the simulation of the product responsive to the preset of values. The method comprises receiving a second user input modifying at least one of the values of the effects data. The method comprises providing, for display in the VTO display region, a modified image with the simulation of the product as modified in response to the second user input.

### FIELD OF INVENTION

The present disclosure relates to image processing and augmented reality and more particularly to methods, apparatus and systems for configuring a virtual try on (VTO) system using pre-configured rendering parameters.

### BACKGROUND

VTO systems enable users to try on products (for example, makeup products, hair products, and nail products) virtually on a computing device before purchasing the products. The rendering engine of the VTO system may be configured for each product. Configuring the rendering engine of the VTO system to include a new product may require fine-tuning a large number of rendering parameters, which may be time consuming and tedious.

Improved techniques are desired to configure the rendering engine of VTO systems.

### SUMMARY

There is provided a computer-implemented method for configuring a rendering engine of a virtual try on (VTO) system comprising executing on a processor one or more steps. The method comprises providing, for display by a display device, a graphical user interface (GUI) that configures a profile of a product to try on through operating of the rendering engine of the VTO system, the profile comprising effects data, and wherein the GUI comprises i) a VTO display region to display a simulation of the product on an image according to values of the effects data; and ii) a plurality of effects controls to receive user input to adjust at least some of the values of the effects data, one of the controls comprising a preset control to define the values of the effects data from a preset of values. The method comprises receiving, via the preset control, a first user input selecting the preset of values. The method comprises providing for display in the VTO display region the image with the simulation of the product responsive to the preset of values. The method comprises receiving, via another of the plurality of effects controls, a second user input modifying at least one of the values of the effects data. The method comprises providing, for display in the VTO display region, a modified image with the simulation of the product as modified in response to the second user input.

The preset control may comprise a plurality of presets, each preset defining a different profile of the product, and wherein the first user input selects one of the plurality of presets.

The GUI may comprise a save control to save the values of the effects data to the profile. The method may further comprise receiving a save input via the save control.

The method may further comprise storing the profile to a product data store.

The method may be executed by a server device in communication with a client device, wherein the first user input and the second user input are received at the server device from the client device, and wherein the client device comprises the display device.

The method may be executed by a client device in communication with a server device, wherein the client device comprises the display device, and wherein the client device receives the GUI and the preset values from the server device.

The method may further comprise sending the profile to the VTO system to display the product to an end user of the VTO system.

The method may further comprise replacing the image with a second image, wherein the image comprises a first model and the second image comprises a second model having a different skin tone from the first model.

The method may further comprise presenting, via the GUI and responsive to selecting via the preset control, one or more high-level controls to receive user input that adjusts the preset of values. The high-level effects control may adjust effect intensity, sparkle, coverage, or brow shape.

The product may comprise a makeup product, a hair product, or a nail product.

The plurality of presets may comprise glow, matte, natural, smoothing, powder, gel, pencil, pomade, satin, pearl, metallic, glossy, twinkle, dewy, natural gloss, high shine, lustre, or texture.

According to a further aspect of the disclosure, there is provided a non-transitory computer-readable medium comprising computer program code stored thereon for configuring a rendering engine of a virtual try on (VTO) system, wherein the code, when executed by one or more processors, causes the one or more processors to perform a method. The method comprises providing, for display by a display device, a graphical user interface (GUI) that configures a profile of a product to try on through operating of the rendering engine of the VTO system, the profile comprising effects data, and wherein the GUI comprises i) a VTO display region to display a simulation of the product on an image according to values of the effects data; and ii) a plurality of effects controls to receive user input to adjust at least some of the values of the effects data, one of the controls comprising a preset control to define the values of the effects data from a preset of values. The method comprises receiving, via the preset control, a first user input selecting the preset of values. The method comprises providing for display in the VTO display region the image with the simulation of the product responsive to the preset of values. The method comprises receiving, via another of the plurality of effects controls, a second user input modifying at least one of the values of the effects data. The method comprises providing, for display in the VTO display region, a modified image with the simulation of the product as modified in response to the second user input.

The method may further comprise performing any of the operations described above in connection with the first aspect of the disclosure.

According to a further aspect of the disclosure, there is provided a system comprising at least one computing device. The system comprises a product data store to store a profile of effects data for a product to configure a rendering engine that simulates a wearing of the product according to the effects data. The system comprises a product effects configurator to receive user input to configure the profile for one of the products, the product effects configurator having a configurator interface providing a preset of values for the effects data, a display region to present an output image that simulates the product applied to an input image according to the effects data, and one or more controls to adjust the preset of values, the configurator interface to update the display region in response to the values as adjusted.

The product effects configurator may have an instance of the rendering engine that defines the output image responsive to the preset of values and the values as adjusted.

One of the controls of the configurator interface may be configured to save the values as adjusted to the data store.

The product effects configurator may be configured to provide the profile to the rendering engine to configure the rendering engine.

The input image may be a user selfie image.

The system may further perform any of the operations described above in connection with the first aspect of the disclosure.

### BRIEF DESCRIPTION OF DRAWINGS

FIG. 1 is an illustration of a computing environment, in accordance with an embodiment, such as for performing a virtual try on.

FIG. 2 is a flowchart of operations such as for a computer implemented method in accordance with an embodiment.

FIG. 3 is an illustration of a representative graphical user interface, in accordance with an embodiment.

FIG. 4 is an illustration of a representative graphical user interface, in accordance with an embodiment.

FIG. 5 is an illustration of a representative graphical user interface, in accordance with an embodiment.

FIG. 6 is an illustration of a representative graphical user interface, in accordance with an embodiment.

### DETAILED DESCRIPTION

In accordance with embodiments herein, there is described one or more methods, systems, apparatus and techniques for configuring a virtual try on (VTO) system.

VTO may provide users with the ability to try on various products (for example, makeup, hair, and nail products) virtually on a device using either the camera (live video mode) or a picture (photo mode). The user may choose the product they want to apply, and the VTO processes the input (video stream or image) to apply a recolouring method and output the processed image that is shown to the user. In live mode this may happen several times per second with a target of 30 frames per second (FPS) on a mobile device.

At a high level, VTO may comprise the following steps: input, detect user feature, recolor user feature. At the input step the image may be provided to be recolored. In case of a live mode this image may be extracted from the video stream of the camera. Detect the user feature may represent the method used to segment the user feature (e.g., hair, lips, eyes, etc.) in the image from the rest (face, background, etc.) and export a mask which will be used to apply the recoloring. Recolor the user feature may be the process of replacing each original pixel of the user feature in the image with a new value from a target color.

Adding new products to the VTO system may require configuring the rendering engine of the VTO by fine-tuning a large number of rendering parameters. The graphical user interface (GUI) of the VTO Configurator may comprise a plurality of effects controls that enable the user to adjust the rendering parameters of the VTO. As the user adjusts the rendering parameters using the effects controls, a VTO display region in the GUI may display a simulation of the product according to the values of the rendering parameters. This may enable the user to adjust the rendering parameters to create a new virtual product. The user may adjust the rendering parameters so that the new virtual product resembles an actual product that is available for purchase. End users of the VTO may virtually try on products, such as makeup products, before purchasing the actual product.

Since a large number of rendering parameters may need to be adjusted, the task of adding a new product to the VTO may be time consuming and tedious. The task may be made more efficient by using pre-configured rendering parameters. The GUI may comprise a preset control. The preset control may be one of the effects controls. The preset control may comprise a plurality of presets, each preset defining a different profile of the product. Each preset of the preset control may be associated with a plurality of preset values for setting the rendering parameters. If the user selects one of the presets of the preset control, the VTO automatically sets all the rendering parameters in accordance with the preset values. The user may select the preset that best approximates the product that the user wishes to add to the VTO. The user may fine-tune the rendering parameters starting from the preset values so that the product more closely resembles the desired result. Less fine-tuning of the rendering parameters may be required as a result since the user starts from preset values that already approximate the desired result. In this way. the process of adding a new product to the VTO may be more efficient.

### VTO Application

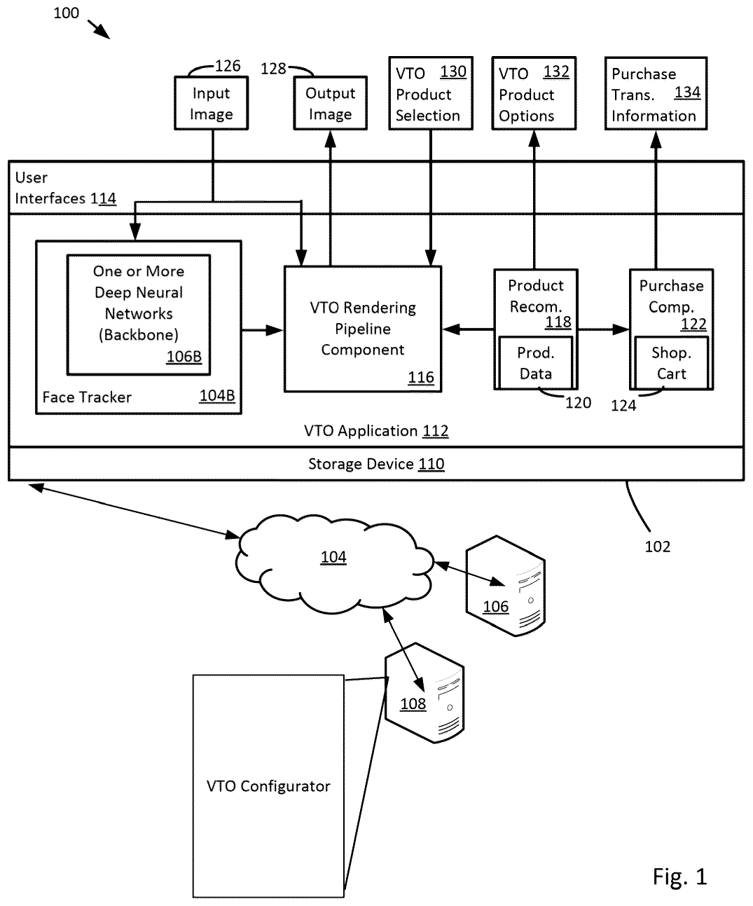

FIG. 1 is an illustration of a computing environment 100, in accordance with an embodiment, such as for practicing one or more method aspects. Computing environment 100 shows a user computing device 102, such as a smartphone, a communications network 104, a server 106 and a server 108. Communications network 104 comprises wired and/or wireless networks, which may be public or private and may include, for example the internet. Server 106 comprises a server computing device such as for providing a website. Server 108 comprises a server computing device such as for providing e-commerce transaction services and the VTO Configurator for configuring the VTO application 112 on the user computing device 102. Though shown separately, the servers 106 and 108 can comprise one server device. Computing environment 100 is simplified. For example, not shown are payment transaction gateways and other components such as for completing an e-commerce transaction.

Computing device 102 comprises a storage device 110 (e.g., a non-transient device such as a memory and/or solid state drive, etc.) for storing instructions that, when executed by a processor (not shown), cause the computing device 102 to perform operations such as a computer implemented method. Storage device 110 stores a virtual try on application 112 comprising components such as software modules providing, a user interface 114, face tracker 104B with one or more deep neural networks 106B, a VTO rendering pipeline component 116, a product recommendation component 118 with product data 120, and a purchasing component 122 with shopping cart 124 (e.g. purchase data).

In an embodiment, VTO application is a web-based application such as is obtained from server 106. Though not shown, user device 102 may store a web-browser for execution of web-based VTO application 112. In an embodiment, VTO application is a native application in accordance with an operating system (also not shown) and software development requirements that may be imposed by a hardware manufacturer, for example, of the user device 102. The native application can be configured for web-based communication or similar communications to servers 106 and 108, as is known.

FIG. 1 shows various input and output data or information associated with a use of VTO application 112, for example. Such includes an input image 126 of the user to be processed for a VTO experience, an output image 128 to which product effects are simulated providing a VTO experience, a VTO product selection 130 comprising user input selecting one or more product effects to be simulated, VTO products options 132 comprising options for products to be virtually tried on, for example for selection by a user of device 102, and purchase transaction information 134 comprising purchase information provided to and/or received from a user to purchase a product.

In an embodiment, via one or more of user interfaces 114, VTO product options 132 are presented for selection to virtually try on by simulating effects on an input image 126. In an embodiment the VTO product options 132 are derived from or associated to product data 120. In an embodiment, the product data can be obtained from server 106 and provided by the product recommendation component 118. Though not shown, user or other input may be received for use to determine product recommendations. The user may be prompted, such as via one of interfaces 114 to provide input for determining product recommendations. In an embodiment, the product recommendation component 118 communicates with server 106. Server 106, in an embodiment, determines the recommendation based on input received via component 118 and provides product data accordingly. User interface 114 can present the VTO product choices, for example, updating the display of same responsive to the data received as the user browses or otherwise interacts with the user interface.

In an embodiment, the one or more user interfaces provide instructions and controls to obtain the input image 126, and VTO product selection input 130 such as an identification of one or more VTO products to try on. In an embodiment, the products may be recommended to a user. In an embodiment, the products may be selected by a user without having been recommended per se. That is, instances of the products may be presented such as from a data store of products and the user selects an instance to virtually try on. In an embodiment, the input image 126 is a user's face image, for example, which can be a still image or a frame from a video. In an embodiment, the input image 126 can be received from a camera (not shown) of device 102 or from a stored image (not shown). The input image 126 is provided to face tracker 104B such as for processing to detect objects in the input image 126 using one or more deep neural networks 106B. In an example, the network classifies, localizes or segments for a specific object in the image.

In an embodiment, output (not shown) from the face tracker 104B, such as classification results, localization results or segmentation results for one or more detected objects, is provided to VTO rendering pipeline component 116. The input image 126 is also provided (e.g. made available) to component 116. The VTO product selection 130 is also provided to component 116 for determining which effects are to be rendered. In an embodiment related to makeup simulation, one or more effects can be indicated such as for any one or more of the product categories comprising: lip, eye shadow, eyeliner, blush, etc.

VTO rendering pipeline component 116, in an embodiment, determines whether to render one or more product effects to the input image 126 to simulate a try on. In an embodiment such as one that is related to makeup, for example, responsive to facemask classification output, VTO rendering pipeline component 116 can determine not to render a product effect to all or a portion of a face, for example, because a mask is detected. When a facemask is detected, for example, VTO rendering pipeline component 116 can trigger the user interface 414 to ask the user to remove the facemask. A new image can be received and processed by face tracker 104B. In an embodiment, images are continuously received as a component of a live stream (e.g. a selfie video).

For example, in an embodiment where more than one product effect is to be applied to the input image, the VTO rendering pipeline component 116 may render effects (e.g. on or to) for the input image 126 such as by drawing (rendering) effects in layers, one layer for each product effect, to produce output image 128. Layering may be assisted by use of overlays in some examples. Some examples may change pixel values of the input image itself without overlaying, per se.

Portions of the operations of VTO rendering pipeline component 116 (e.g. such as for drawing the layers) can be performed by a graphics processing unit, in an embodiment. The rendering is in accordance with product data 120 as selected by VTO product selection 130 and is responsive to the location of detected objects. For example, a VTO product selection of a lipstick, lip gloss or other lip related product invokes the application of an effect to one or more detected mouth or lip-related objects at respective locations. Similarly a brow related product selection invokes the application of a selected product effect to the detected eyebrow objects. Typically, for symmetrical looks, the same brow effects are applied to each brow, the same lip effect to each lip or the same eye effect to each eye region, but this need not be the case. In an example, the rendering is applied to a region that is relative to the detected objects, such as adjacent one or more such detected objects. Some VTO product selections comprise a selection of more than one product such as coordinated products for brows and eyes or other combinations of detected objects. VTO rendering pipeline component 116 can render each effect, for example, one at a time until all effects are applied. The order of application can be defined by rules or in the selection of products e.g. lipstick before a top gloss.

In an embodiment where an occluding object is detected and the location is determined, for example, as represented in a segmentation mask, the rendering can be responsive to such a segmentation mask. Rendering of an effect can be applied to portions of the face that are not occluded. A segmentation mask can indicate the pixels of the face that are available to (e.g. may) receive an effect such as a makeup effect and those pixels that are not available to receive an effect.

User interfaces 114 provide the output image 128. Output image 128, in an embodiment, is presented as a portion of a live stream of successive output images (each an example 128) such as where a selfie video is augmented to present an augmented reality experience. In an embodiment, output image 128 is presented along with the input image 126, such as in a side-by-side display for comparison. In an embodiment, output image 128 can be saved (not shown) such as to storage device 110 and/or shared (not shown) with another computing device.

In an embodiment, (not shown) the input images comprise input images of a video conferencing session and the output images comprise a video that is shared with another participant (or more than one) of a video conferencing session. In an embodiment the VTO application is a component or plug in of a video conferencing application (not shown) permitting the user of device 102 to wear makeup during a video conference with one or more other conference participants.

### VTO Configurator

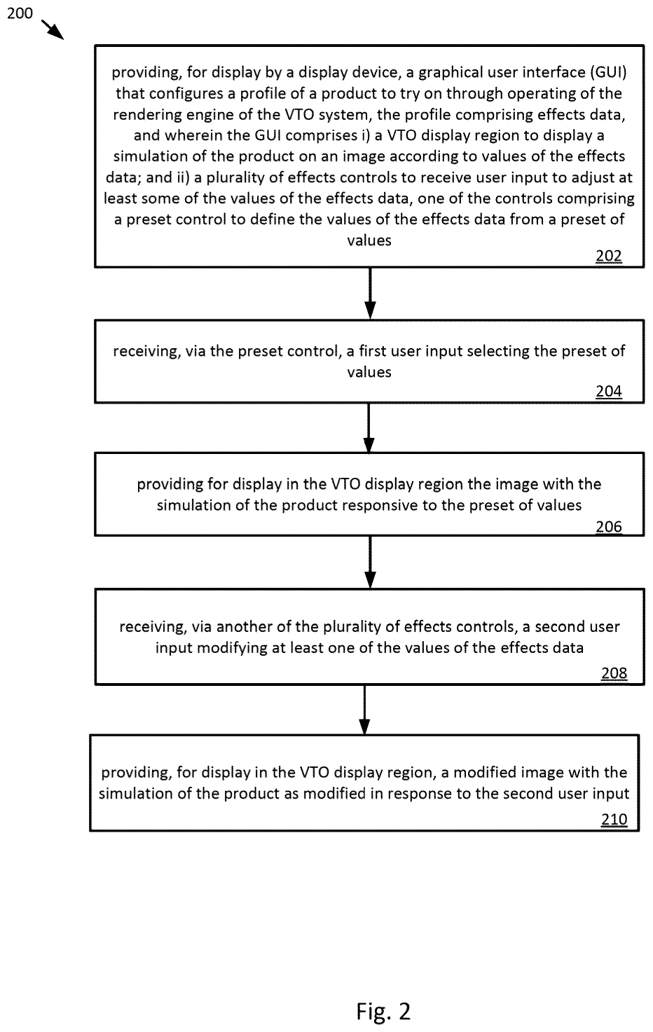

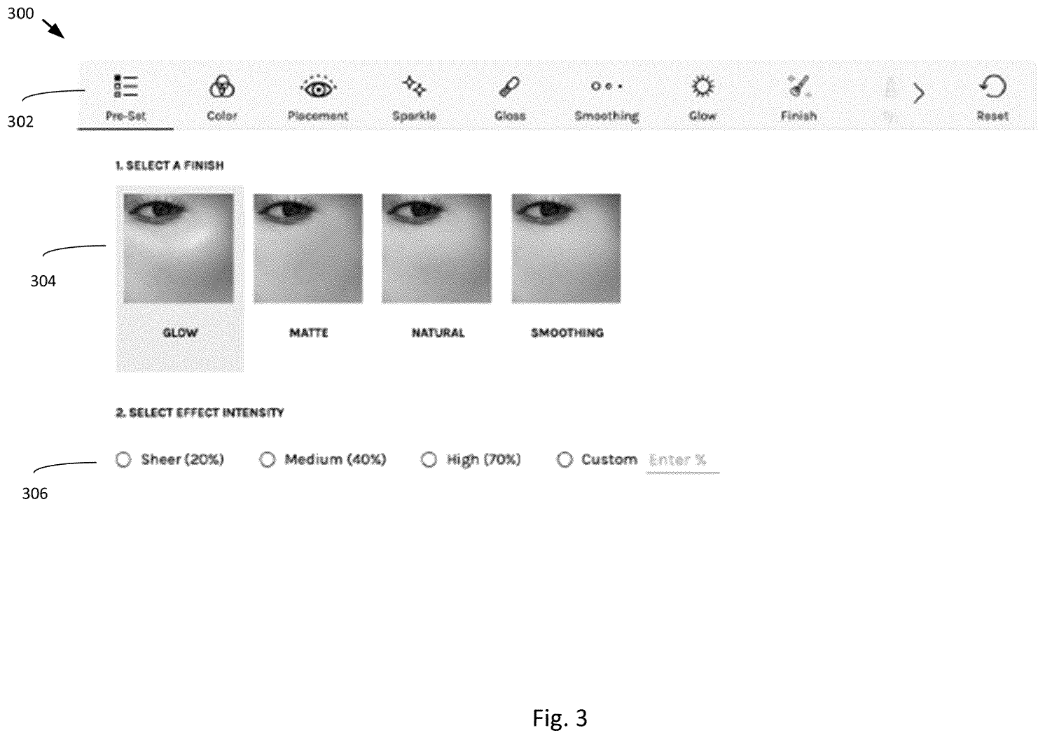

Reference is now made to FIG. 2, which shows a computer-implemented method 200 for configuring a rendering engine of a VTO system 102. The rendering engine may be a component of a VTO rendering pipeline 116. Reference is also made to FIG. 3, which shows part of an exemplary graphical user interface (GUI) 300 of the VTO Configurator. The method 200 comprises providing, for display by a display device, a GUI that configures a profile of a product to try on through operating of the rendering engine of the VTO system 102, the profile comprising effects data, and wherein the GUI comprises i) a VTO display region (not shown) to display a simulation of the product on an image 126 according to values of the effects data; and ii) a plurality of effects controls 302 to receive user input to adjust at least some of the values of the effects data, one of the controls 302 comprising a preset control to define the values of the effects data from a preset of values 202.

The VTO Configurator may be executed by server 108, as shown in FIG. 1. The VTO Configurator may alternatively be executed by server 106 or directly on the VTO system 102. The VTO Configurator may configure a new product for storage on server 106 or 108. Alternatively, the VTO Configurator may configure a new product by directly configuring the VTO rendering engine on the VTO system 102. The VTO Configurator may be used to configure a new product, such as a makeup product, that an end user may virtually try on as part of a virtual try on experience using the VTO system 102.

The plurality of effects controls 302 comprise a preset control. The plurality of effects controls 302 may further comprise a color control, a placement control, a sparkle control, a gloss control, a smoothing control, a glow control, as well as other controls for adjusting the effects data for the new product.

The preset control may comprise plurality of presets or options 304. The presets 304 may be referred to as finishes. The presets 304 may comprise glow, matte, natural, and smoothing options. Each preset 304 of the preset control may correspond to a different preset of values.

The method 200 further comprises receiving, via the preset control, a first user input selecting the preset of values 204. The user may select the preset of values for the effects data by selecting from among the presets 304. For example, the presets 304 may be buttons that the user selects by clicking. For example, the user may click on the glow preset to select the glow preset. The glow preset may be associated with the following preset of values: gamma of 0, a blushGlow of 0.5, and a skinClearing of 0. As another example, the user may click on the matte preset to select the matte preset. The matte preset may be associated with the following preset of values: gamma of 0, a blushGlow of 0, and a skinClearing of 0. Similarly, the user may click on the natural or smoothing presets to select those presets. The preset of values for gamma, blushGlow, and skinClearing may be the effects data that define the profile of the new product.

The method 200 further comprises providing for display in the VTO display region the image 128 with the simulation of the product responsive to the preset of values 206. The method modifies an input image 126 to generate the output image 128 with the simulation of the product based on the preset of values. The input image 126 may be an image of a model. The input image 126 may be an image of the user. The input image 126 may be a frame of a video of the user. For example, if the product is a blush makeup product, the blush may be virtually applied to the input image 126 of the user to generate the output image 128 of the user wearing the blush. Based on the output image 128 displayed in the VTO display region, the user may determine whether the preset of values generates a desired virtual try on experience for the product. For example, if the user is attempting to reproduce an actual makeup product in the VTO system 102, the user may use the simulation in the VTO display region to determine whether the simulation of the makeup product accurately reproduces the actual makeup product.

The method 200 further comprises receiving, via another of the plurality of effects controls, a second user input modifying at least one of the values of the effects data 208. If the simulation of the product does not achieve the desired result, the user may adjust the effects data by providing a second user input via the effects controls 302. For example, if the user selected the glow preset, the effects data may comprise a blushGlow of 0.5. The user may use the glow effect control to adjust this blushGlow value. For example, the user may set the blushGlow value to 0.6 based on the appearance of the product in the VTO display region.

The method 200 further comprises providing, for display in the VTO display region, a modified image 128 with the simulation of the product as modified in response to the second user input 210. The image 128 in the VTO display region may be updated in real-time as the user adjusts the effects data using the plurality of effects data controls 302. In this manner, the user can fine tune the virtual product to efficiently achieve the desired result for the VTO experience. For example, if the user uses the glow control to increase the glow of a blush product, the glow of the product in the VTO display region may automatically increase in real-time. This may allow the user to see whether the adjustment achieves the desired result and better approximates the actual blush makeup product. The user may continue to adjust the effects data in response to the updated image 128 until the desired result is achieved.

The preset of values sets a plurality of values of the effects data approximate to the product that the user wishes to create. The user may then further adjust the effects data using the plurality of effects controls 302 to achieve a better result. As the user adjusts the effects data, the simulation of the product in the VTO display region may be updated in real-time, allowing the user to see the result of the fine tuning. This feedback loop process may continue until the user achieves the desired result for the product. Creating a new product for a VTO system 102 may require the setting of a large number of rendering parameters. This can be time consuming and inefficient. By using a preset of values, a large number of the rendering parameters can be set approximately to what the user desires. Thus the user may have to make a few minor adjustments to achieve the desired result. This is an easier and more efficient process for the user to create a new product for the VTO system 102. It is also a more efficient process for the computer system. Since the user may need to go through fewer iterations to achieve the desired result by starting with a preset of values, the computer may need to generate fewer simulation images 128, which results in less processing power used to achieve the desired result.

The preset control may comprise a plurality of presets 304, each preset defining a different profile of the product, and wherein the first user input selects one of the plurality of presets. The user may select the preset of values for the effects data by selecting from among the presets 304. Each preset 304 may be associated with a different preset of values that define a different profile of the product. For example, the presets 304 may be buttons that the user selects by clicking. For example, the user may click on the glow preset to select the glow preset. The glow preset may be associated with the following preset of values: gamma of 0, a blushGlow of 0.5, and a skinClearing of 0. As another example, the user may click on the matte preset to select the matte preset. The matte preset may be associated with the following preset of values: gamma of 0, a blushGlow of 0, and a skinClearing of 0. Similarly, the user may click on the natural or smoothing presets to select those presets. The preset of values for gamma, blushGlow, and skinClearing may be the effects data that define the profile of the new product. In some embodiments, the user may be able to select more than one preset.

The GUI 300 may comprise a save control to save the values of the effects data to the profile. The method 200 may further comprise receiving a save input via the save control. The profile for the product may be saved on server 108 or server 106. The profile may be saved on storage device 110 of the VTO system 102. The method 200 may further comprise storing the profile to a product data store. The server 106 or 108 may comprise a product data store, such as a database, for storing the profile comprising the effects data for the product for later retrieval by the VTO system 102. The product data store may alternatively reside on the VTO system 102.

The method 200 may be executed by server device 108 in communication with a client device (not shown), wherein the first user input and the second user input are received at the server device 108 from the client device, and wherein the client device comprises the display device. The VTO Configurator may be implemented using a client-server model, where the first user input and second user input are received at the client device and sent to the server 108 via the network 104. The server 108 may send the simulation for display to the user on a display device of the client device. In some embodiments, the client device may be the VTO system 102. In some embodiments, the VTO Configurator may be implemented as a web application. The user may configure the new product in the VTO Configurator on the server 108 via a web interface. In other embodiments, the user may create the new product using the VTO configurator on a mobile device via an app that is connected to the server 108 via the network 104.

The method 200 may be executed by a client device (not shown) in communication with a server device 108, wherein the client device comprises the display device, and wherein the client device receives the GUI and the preset values from the server device 108. In some embodiments, the VTO Configurator may be executed locally on the user's client device. The VTO Configurator may have the preset values and GUI stored locally. Alternatively, the VTO Configurator may retrieve the preset values and GUI from the server 106 or the server 108 via the network 104. The user may create the profile for the new product locally on the client device. The client device may upload the profile for the new product to the server 106 or the server 108. In some embodiments, the client device may be the VTO system 102.

The method 200 may further comprise sending the profile to the VTO system 102 to display the product to an end user of the VTO System 102. The VTO System 102 may recommend the product to the end user. Alternatively, the end user may select the product on the VTO System 102 from a list of possible products. The VTO System 102 may request the product profile from the server 106 or the server 108, for example from a product database or data store, in response to the end user's request. The server 106 or the server 108 may send the profile of the product to the VTO System 102 in response to the user's request. Alternatively, the server 106 or the server 108 may send a plurality of profiles to the VTO system 102 in bulk, and the VTO system may store the profiles locally as product data 120. The VTO System 102 may provide a VTO experience for the user by simulating the product on an image 126 of the user. The profile effects data may be used to configure the VTO rendering engine of the VTO System 102 such that the VTO system 102 modifies an input image 126 of the user to provide an output image 128 of the user to generate a virtual try on experience.

The method 200 may further comprise replacing the image 126 with a second image (not shown), wherein the image 126 comprises a first model and the second image comprises a second model having a different skin tone from the first model. Products, such as makeup, hair, and nail products, may look different on people with different skin tones. To ensure that the product looks realistic on end users with different skin tones, the user creating the new product may try simulating the product on images of models with different skin tones. The user may adjust the effects data accordingly. The user may create different profiles for the product for different skin tones.

There may be different preset controls for different types of products. The user may select the type of product in the GUI. The GUI may provide different presets or options for the preset control in response to the selection made. FIG. 3 shows a GUI 300 comprising a preset control for a blush makeup product. The blush preset control may comprise a finish preset control 304. The finish preset control 304 may comprise the presets glow, matte, natural, and smoothing. Each preset may correspond to a different preset of values as shown in Table 1 that follows:

TABLE 1

| Preset | Preset Values |
|---|---|
| Glow | gamma: 0; blushGlow: 0.5; skinClearing: 0 |
| Matte | gamma: 0; blushGlow: 0; skinClearing: 0 |
| Natural | gamma: 1.0; blushGlow: 0; skinClearing: 0 |
| Smoothing | gamma: 0; blushGlow: 0; skinClearing: 0.5 |

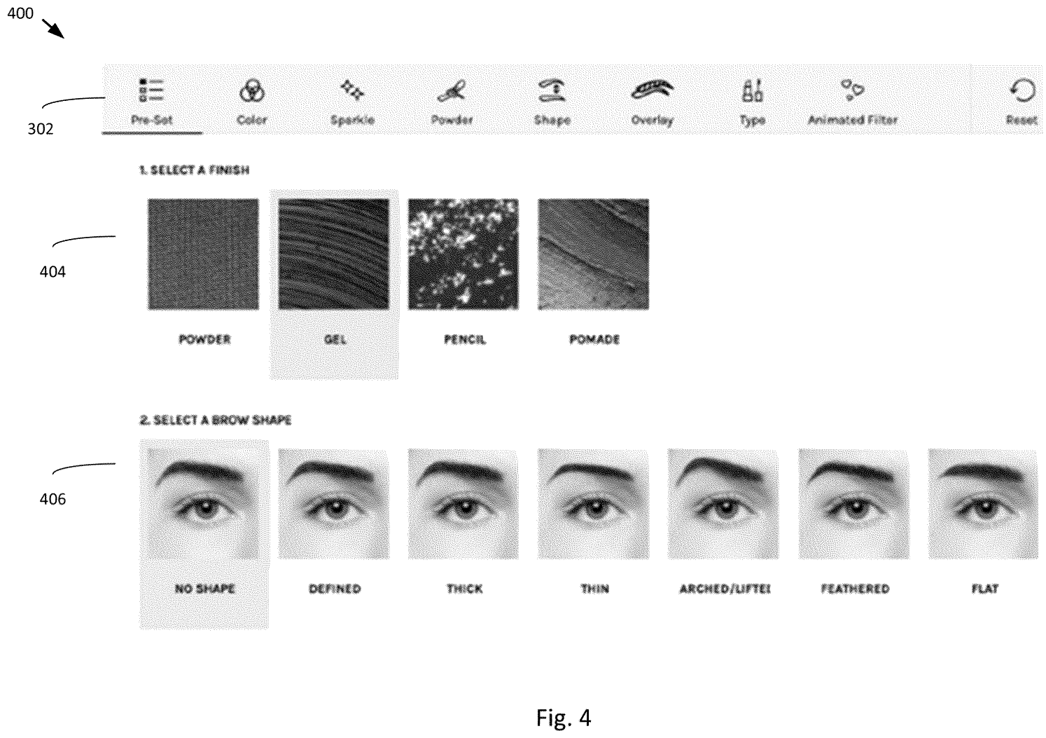

FIG. 4 shows a GUI 400 for a brow makeup product. The brow preset control may comprise a finish preset control 404. The finish preset control 404 for the brow product may comprise the presets powder, gel, pencil, and pomade. Each preset may correspond to a different preset of values as shown in Table 2 that follows:

TABLE 2

| Preset | Preset Values |
|---|---|
| Powder | powderIntensity: 0.5; cleaning_bottom: 0; cleaning_top: 0; |
| | inner_thickness: 0; middle_thickness: 0 |
| Gel | powderIntensity: 0; cleaning_bottom: 0.05; cleaning_top: 0; |
| | inner_thickness: 0.2; middle_thickness: 0.1 |
| Pencil | powderIntensity: 0; cleaning_bottom: 0.15; cleaning_top: 0.1; |
| | inner_thickness: 0; middle_thickness: 0 |
| Pomade | powderIntensity: 0; cleaning_bottom: 0.1; cleaning_top: 0.1; |
| | inner_thickness: 0; middle_thickness: 0 |

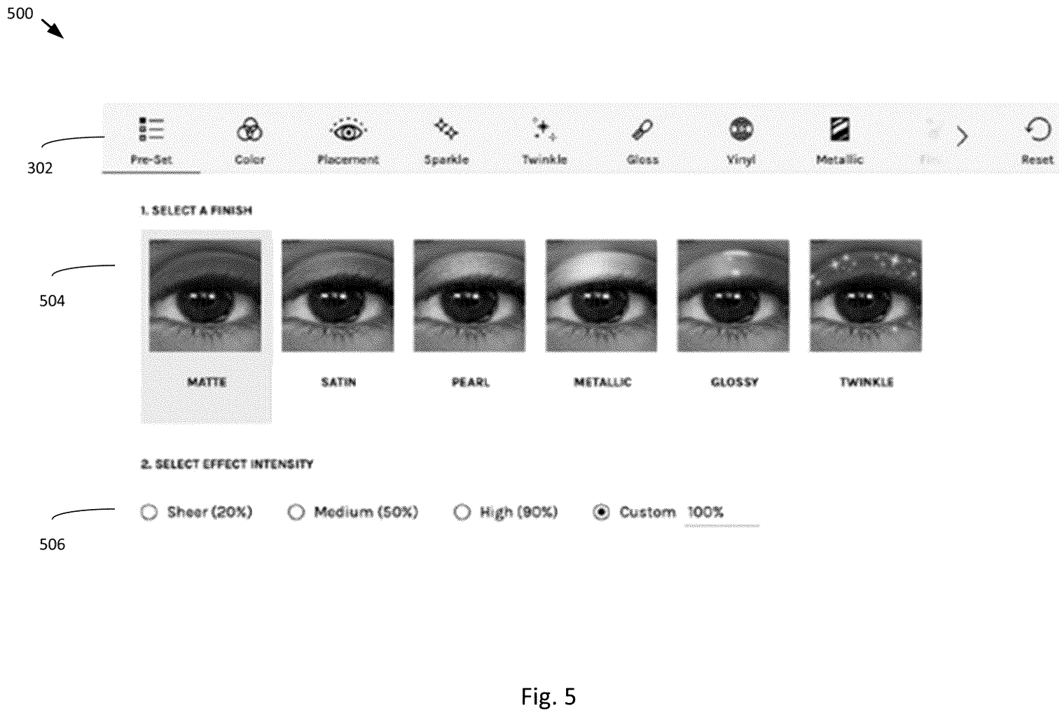

FIG. 5 shows a GUI 500 comprising a preset control for an eyeshadow makeup product. The eyeshadow preset control may comprise a finish preset control 504. The finish preset control 504 may comprise the presets matte, satin, pearl, metallic, glossy, and twinkle. Each preset may correspond to a different preset of values as shown in Table 3 that follows:

TABLE 3

| Preset | Preset Values |
|---|---|
| Matte | gamma: 0; useLegacyGlitter: 0; sparkleIntensity: 0; |
| | sparkleBaseReflectivity: 0.7; sparkleSize: 2.08; |
| | use_v2_metallic: 1; metallicIntensity: 0; |
| | twinkleR: 255; twinkleG: 255; twinkleB: 255; |
| | twinkleIntensity: 0; twinkleDensity: 0.5; twinkleSize: 1 |
| Satin | gamma: 0.5; useLegacyGlitter: 0; sparkleIntensity: 0; |
| | sparkleBaseReflectivity: 0.7; sparkleSize: 2.08; |
| | use_v2_metallic: 1; metallicIntensity: 0; |
| | twinkleR: 255; twinkleG: 255; twinkleB: 255; |
| | twinkleIntensity: 0; twinkleDensity: 0.5; twinkleSize: 1 |
| Pearl | gamma: 1.0; useLegacyGlitter: 0; sparkleIntensity: 0.3; |
| | sparkleBaseReflectivity: 0.7; sparkleSize: 2.08; |
| | use_v2_metallic: 1; metallicIntensity: 0; |
| | twinkleR: 255; twinkleG: 255; twinkleB: 255; |
| | twinkleIntensity: 0; twinkleDensity: 0.5; twinkleSize: 1 |
| Metallic | gamma: 0.75; useLegacyGlitter: 0; sparkleIntensity: 0; |
| | sparkleBaseReflectivity: 0.7; sparkleSize: 2.08; |
| | use_v2_metallic: 1; metallicIntensity: 0.45; |
| | twinkleR: 255; twinkleG: 255; twinkleB: 255; |
| | twinkleIntensity: 0; twinkleDensity: 0.5; twinkleSize: 1 |
| Glossy | gamma: 1.5; useLegacyGlitter: 0; sparkleIntensity: 0; |
| | sparkleBaseReflectivity: 0.7; sparkleSize: 2.08; |
| | use_v2_metallic: 1; metallicIntensity: 0; |
| | twinkleR: 255; twinkleG: 255; twinkleB: 255; |
| | twinkleIntensity: 0; twinkleDensity: 0.5; twinkleSize: 1 |
| Twinkle | gamma: 0; useLegacyGlitter: 0; sparkleIntensity: 0; |
| | sparkleBaseReflectivity: 0.7; sparkleSize: 2.08; |
| | use_v2_metallic: 1; metallicIntensity: 0; |
| | twinkleR: 255; twinkleG: 255; twinkleB: 255; |
| | twinkleIntensity: 0.85; twinkleDensity: 0.3; twinkleSize: 0.92 |

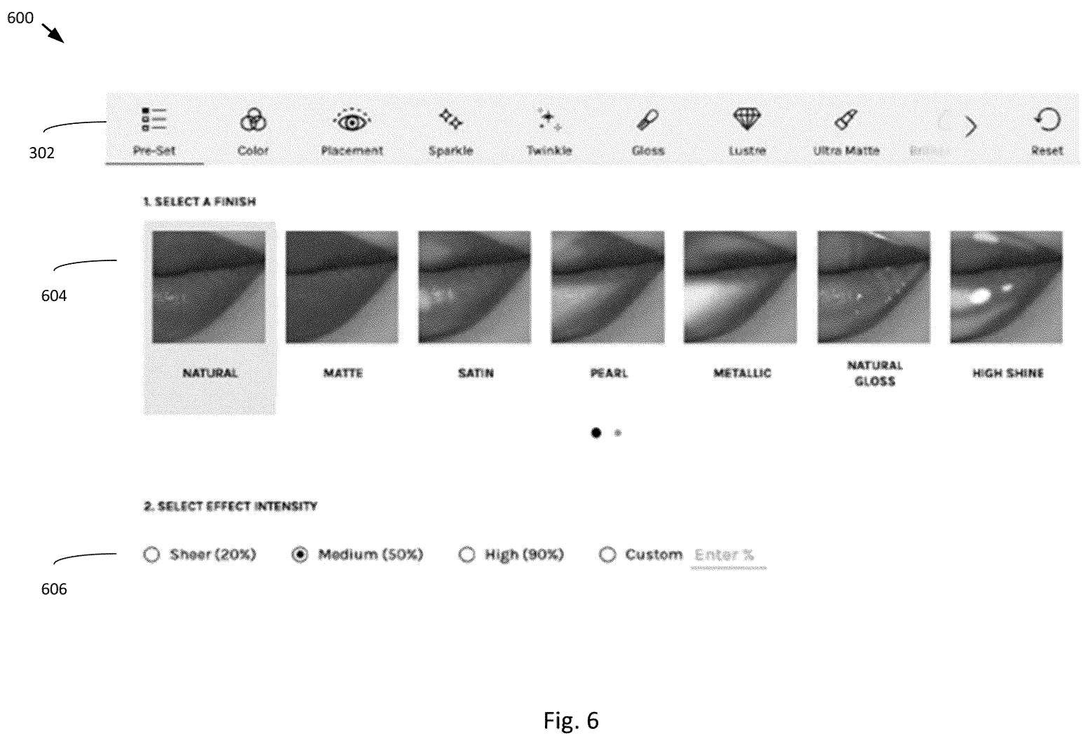

FIG. 6 shows a GUI 600 comprising a preset control for a lip color makeup product. The lip color preset control may comprise a finish preset control 604. The finish preset control 604 may comprise the presets natural, matte, satin, pearl, metallic, natural gloss, high shine, lustre, smoothing, and texture. Each preset may correspond to a different preset of values as shown in Table 4 that follows:

TABLE 4

| Preset | Preset Values |
|---|---|
| Natural | gamma: 1.0; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0 |
| Matte | gamma: 0; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0 |
| Satin | gamma: 0.5; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0 |
| Pearl | gamma: 1.0; useLegacyGlitter: 0; sparkleIntensity: 0.3; |
| | sparkleBaseReflectivity: 0.7; sparkleSize: 2.04; |
| | metallicIntensity: 0; lustre: 0; glossDetail: 0; |
| | textureBoost: 0 |
| Metallic | gamma: 0; useLegacyGlitter: 0; sparkleIntensity: 0; |
| | sparkleBaseReflectivity: 0.7; sparkleSize: 2.04; |
| | metallicIntensity: 0.5; lustre: 0; glossDetail: 0; |
| | textureBoost: 0 |
| Natural Gloss | gamma: 1.75; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0 |
| High Shine | gamma: 3.25; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0 |
| Lustre | gamma: 0; useLegacyGlitter: 0; sparkleIntensity: 0; |
| | sparkleBaseReflectivity: 0.7; sparkleSize: 2.04; |
| | metallicIntensity: 0; lustre: 0.5; glossDetail: 0; |
| | textureBoost: 0 |
| Smoothing | gamma: 2.5; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0.5; |
| | textureBoost: −0.7 |
| Texture | gamma: 0; useLegacyGlitter: 0; sparkleIntensity: 0; |
| | sparkleBaseReflectivity: 0.7; sparkleSize: 2.04; |
| | metallicIntensity: 0; lustre: 0; glossDetail: 0; |
| | textureBoost: 0.3 |

The method 200 may further comprise presenting, via the GUI and responsive to selecting via the preset control, one or more high-level controls to receive user input that adjusts the preset of values. The high-level effects control may comprise effect intensity, sparkle, coverage, or brow shape. For the blush makeup product, the high-level control may comprise effect intensity 306. The effect intensity high-level control 306 may comprise the options sheer, medium, high, and custom. Custom may enable the user to enter a custom intensity as a percent. For the brow makeup product, the high-level control may comprise brow shape 406. The brow-shape high-level control 406 may allow the user to select the shape of the brow in the output image 128. The brow-shape high-level control 406 may comprise the options no shape, defined, thick, thin, arched/lifted, feathered, and flat. For the eyeshadow makeup product, the high-level control may comprise effect intensity 506. The effect intensity high-level control 506 may comprise the options sheer, medium, high, and custom. For the lip color makeup product, the high-level control may comprise effect intensity 606. The effect intensity high-level control 606 may comprise the options sheer, medium, high, and custom.

The VTO Configurator may be used to create a makeup product, a hair product, or a nail product.

The method 200 may be implemented on a system 100. The system 100 comprises a product data store to store a profile of effects data for a product to configure a VTO rendering engine that simulates a try on of the product according to the effects data to provide a VTO experience. The product data store may be executed on server 106, server 108, or VTO system 102.

The system 100 further comprises a product effects configurator to receive user input to configure the profile for one of the products, the product effects configurator having a configurator interface providing a preset of values for the effects data, a display region to present an output image 128 that simulates the product applied to an input image 126 according to the effects data, and one or more effects controls 302 to adjust the preset of values, the configurator interface to update the display region in response to the values as adjusted. The product effects configurator may be executed on server 106 or server 108. The product effects configurator may be executed on a client computing device, such as VTO system 102.

The product effects configurator may have an instance of the VTO rendering engine that defines the output image 128 responsive to the preset of values and the values as adjusted. The product effects configurator may use the VTO rendering engine of the VTO system 102. Alternatively, the product effects configurator may have its own VTO rendering engine. The product effects configurator's VTO rendering engine may be used to produce a simulation in real-time of the product being created to enable the user to adjust the effects data of the product in response to how it looks in the simulation displayed in the VTO display region.

One of the controls of the configurator interface may be configured to save the values as adjusted to the data store. When the user selects the save control, the current profile of the product may be saved to a database or a data store for future use by an end user as part of a VTO experience.

The product effects configurator may be configured to provide the profile to a VTO system 102 to configure the VTO rendering engine. The VTO system 102 may recommend the product to an end user. The end user may alternatively select the product on the VTO system 102 from a list of available products. The VTO system 102 may request the profile of the product from the product data store on server 106 or server 108 in response to the user's selection or the recommendation. The server 106 or server 108 may send the profile of the product to the VTO system 102 via the network 104. The rendering engine of the VTO system 102 may use the profile to modify the input image 126 of the user to apply the product to the user to generate the output image 128.

The input image 126 may be a user selfie image. The input image 126 may be the image of a model. The input image 126 may be a live video of the user.

It will be understood that corresponding system embodiments are disclosed for each of the method embodiments disclosed herein, for example where the system comprises respective components having computation circuitry configured to perform the operations of the computer implemented method embodiments.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored therein.

While the computing devices are described with reference to processors and instructions that, when executed, cause the computing devices to perform operations, it is understood that other types of circuitry than programmable processors can be configured. Hardware components comprising specifically designed circuits can be employed such as but not limited to an application specific integrated circuit (ASIC) or other hardware designed to perform specific functions, which may be more efficient in comparison to a general-purpose central processing unit (CPU) programmed using software. Thus, broadly herein an apparatus aspect relates to a system or device having circuitry (sometimes referenced as computational circuitry) that is configured to perform certain operations described herein, such as, but not limited, to those of a method aspect herein, whether the circuitry is configured via programming or via its hardware design.

Practical implementation may include any or all the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All the features disclosed herein (including any accompanying claims, abstract and drawings), and/or all the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer-implemented method for configuring a rendering engine of a virtual try on (VTO) system, the method comprising executing on a processor one or more steps comprising:
providing, for display by a display device, a graphical user interface (GUI) that configures a profile of a product to try on through operating of the rendering engine of the VTO system, the profile comprising effects data, and wherein the GUI comprises i) a VTO display region to display a simulation of the product on an image according to values of the effects data; and ii) a plurality of effects controls to receive user input to adjust at least some of the values of the effects data, one of the controls comprising a preset control to define the values of the effects data from a preset of values;
receiving, via the preset control, a first user input selecting the preset of values;
providing for display in the VTO display region the image with the simulation of the product responsive to the preset of values;
receiving, via another of the plurality of effects controls, a second user input modifying at least one of the values of the effects data; and
providing, for display in the VTO display region, a modified image with the simulation of the product as modified in response to the second user input.

2. The computer-implemented method of claim 1, wherein the preset control comprises a plurality of presets, each preset defining a different profile of the product, and wherein the first user input selects one of the plurality of presets.

3. The computer-implemented method of claim 1, wherein the GUI comprises a save control to save the values of the effects data to the profile, the method further comprising receiving a save input via the save control.

4. The computer-implemented method of claim 1, further comprising storing the profile to a product data store.

5. The computer-implemented method of claim 1, wherein the method is executed by a server device in communication with a client device, wherein the first user input and the second user input are received at the server device from the client device, and wherein the client device comprises the display device.

6. The computer-implemented method of claim 1, wherein the method is executed by a client device in communication with a server device, wherein the client device comprises the display device, and wherein the client device receives the GUI and the preset values from the server device.

7. The computer-implemented method of claim 1, further comprising sending the profile to the VTO system to display the product to an end user of the VTO system.

8. The computer-implemented method of claim 1, further comprising replacing the image with a second image, wherein the image comprises a first model and the second image comprises a second model having a different skin tone from the first model.

9. The computer-implemented method of claim 1, further comprising presenting, via the GUI and responsive to selecting via the preset control, one or more high-level controls to receive user input that adjusts the preset of values.

10. The computer-implemented method of claim 9, wherein the high-level effects control adjusts effect intensity, sparkle, coverage, or brow shape.

11. The computer-implemented method of claim 1, wherein the product comprises a makeup product, a hair product, or a nail product.

12. The computer-implemented method of claim 2, wherein the plurality of presets comprises glow, matte, natural, smoothing, powder, gel, pencil, pomade, satin, pearl, metallic, glossy, twinkle, dewy, natural gloss, high shine, lustre, or texture.

13. A non-transitory computer-readable medium comprising computer program code stored thereon for configuring a rendering engine of a virtual try on (VTO) system, wherein the code, when executed by one or more processors, causes the one or more processors to perform a method comprising:
providing, for display by a display device, a graphical user interface (GUI) that configures a profile of a product to try on through operating of the rendering engine of the VTO system, the profile comprising effects data, and wherein the GUI comprises i) a VTO display region to display a simulation of the product on an image according to values of the effects data; and ii) a plurality of effects controls to receive user input to adjust at least some of the values of the effects data, one of the controls comprising a preset control to define the values of the effects data from a preset of values;
receiving, via the preset control, a first user input selecting the preset of values;
providing for display in the VTO display region the image with the simulation of the product responsive to the preset of values;
receiving, via another of the plurality of effects controls, a second user input modifying at least one of the values of the effects data; and
providing, for display in the VTO display region, a modified image with the simulation of the product as modified in response to the second user input.

14. The computer-readable medium of claim 13, wherein the preset control comprises a plurality of presets, each preset defining a different profile of the product, and wherein the first user input selects one of the plurality of presets.

15. The computer-readable medium of claim 13, wherein the GUI comprises a save control to save the values of the effects data to the profile, the method further comprising receiving a save input via the save control.

16. The computer-readable medium of claim 13, further comprising storing the profile to a product data store.

17. The computer-readable medium of claim 13, wherein the non-transitory computer-readable medium is part of a server device in communication with a client device, wherein the first user input and the second user input are received at the client device, and wherein the client device comprises the display device.

18. The computer-readable medium of claim 13, wherein the non-transitory computer-readable medium is part of a client device in communication with a server device, wherein the client device comprises the display device, and wherein the client device receives the GUI and the preset values from the server device.

19. The computer-readable medium of claim 13, further comprising presenting, via the GUI and responsive to selecting via the preset control, one or more high-level controls to receive user input that adjusts the preset of values.

20. A system comprising at least one computing device, the system comprising:
a product data store to store a profile of effects data for a product to configure a rendering engine that simulates a wearing of the product according to the effects data; and
a product effects configurator to receive user input to configure the profile for one of the products, the product effects configurator having a configurator interface providing a preset of values for the effects data, a display region to present an output image that simulates the product applied to an input image according to the effects data, and one or more controls to adjust the preset of values, the configurator interface to update the display region in response to the values as adjusted.

21. The system of claim 20, wherein the product effects configurator has an instance of the rendering engine that defines the output image responsive to the preset of values and the values as adjusted.

22. The system of claim 20, wherein one of the controls of the configurator interface are configured to save the values as adjusted to the data store.

23. The system of claim 20, wherein the product effects configurator is configured to provide the profile to the rendering engine to configure the rendering engine.

24. The system of claim 20, wherein the input image is a user selfie image.
